(19) United States
(12) Patent Application Publication
(10) Pub. No.: US 2007/0040411 A1
(43) Pub. Date: Feb. 22, 2007

(54) Door panel with temporary supports for logistic of a trim door module of an automobile

(76) Inventor: Jean Dauvergne, Fosses (FR)

Correspondence Address: VISTEON, C/O BRINKS HOFER GILSON & LIONE, PO BOX 10395, CHICAGO, IL, 60610, US

(21) Appl. No.: 11/496,209

(22) Filed: Jul. 31, 2006

(30) Foreign Application Priority Data
Jul. 29, 2005 (FR) 05 08168

(51) Int. Cl. B60J 5/00

(52) U.S. Cl. 296/146.7; 49/502

(57) ABSTRACT

A temporary fixing unit for two components. The temporary fixing unit includes at least two openings present in one of said components and at least two corresponding male parts of the other of said components. The male parts being designed to be elastically engaged openings and to be withdrawn therefrom without the need for a tool. Each male part consists of three portions namely, a first end portion designed to traverse the corresponding opening and to engage against the edges thereof, a second end portion of lateral or sectional dimensions greater than the passage dimensions of the openings, and an intermediate portion situated between the edges of the corresponding opening in the inserted position of the end portion in the hollow or open volume into which the opening opens.

### BACKGROUND

1. Field of the Invention

The present invention relates to temporary fixing means for two components and relates more particularly to a temporary fixing unit for two components, preferably in the form of plates, panels or the like. It also relates to an assembly process for an interior vehicle door trim, and a door panel produced according to this assembly process.

2. Description of Related Art

In general, temporary fixing means must fulfill a certain number of functions such as having both fairly high resistance, to removal, so that the two components connected to each other by means of these temporary fixing means do not separate, while being easily removable without using tools. Moreover, these fixing means must not, if possible, cause either breakage or rupture when the two components are separated.

Moreover, in some circumstances it is necessary, to meet the speed of assembly and productivity requirements of assembly lines, to be able to connect two components together temporarily by means of a fixing means that is not independent or separate from one of the components to be temporarily connected. In general, when temporarily assembling two components, this disposes of the need for an additional stage of providing the fixing means during which at least one of the two components is held in a certain position by an appropriate device to allow the operator to grasp the assembly means.

However, numerous temporary fixing means do not meet these requirements and, because they provide a positive connection between two components must, to be released, be subjected to great force that can only be applied by means of a tool and that cannot be reproduced.

In this context, the French patent application FR-A-2 851 205 describes an assembly process for a door module comprising a trim and a window raising track fixed to said trim, that can be separated by a temporary fixing means. When the track is attached to the door housing, the position of the trim is such that it allows easy assembly of the window. Next, the trim is separated from the track by releasing the temporary fixing means and then the trim is fixed in the assembly position on the door.

The temporary fixing means described in this document may be a fastener that can be broken to separate the track from the trim either by a sudden movement of the trim in relation to the track hooked to the door, or by a blow from a cutting tool.

However, breaking the fastener requires a certain uncalibrated and unquantified force and is produced by means of a violent uncontrolled movement. This can be a drawback in an assembly chain. Thus, if an operator does not succeed in breaking the fastener in a single attempt, he must repeat the breaking operation causing a slow-down in the assembly chain that is passed on in the assembly costs. The operator may also mishandle the operation and injure himself to break the fastener.

In addition, the fastener may not always break in the same place, resulting in one of the two separate pieces of said fastener interfering with the final assembly of the trim on the door.

Moreover, the fact that a cutting tool must be used may also be disadvantageous in that, on the one hand, an additional operation to grasp said tool is necessary and that, on the other hand, after the fastener breaks, the released component must be held and the tool must be replaced in the non-utilization position. The consequence of this is that additional means and time are required, further increasing assembly costs.

The present invention proposes to reduce these drawbacks and produce a temporary fixing unit for which the force necessary to release it can be easily reproduced and produced without the need for tools.

### SUMMARY

Accordingly, the present invention relates to a temporary fixing unit for two components, preferably in the form of plates, panels or the like. The unit that comprises, on the one hand, at least two openings present in the region of the first of said components each opening into a hollow or open volume and, on the other hand, of at least two corresponding male parts of the second element designed to be elastically engaged in said openings and to be released therefrom without the need for a tool. In one aspect, each male part, as seen from the axial or engagement direction of this part, includes three portions, namely, a first end portion is at least slightly deformable and has lateral or sectional dimensions greater than the passage dimensions of the openings in the absence of loading or constraint, while being designed to traverse the corresponding opening and engage against the edges thereof in the inserted position of said first end portion in the volume. A second end portion has lateral or sectional dimensions greater than the passage dimensions of the openings. Finally, an intermediate portion has lateral or sectional dimensions at least slightly less than the passage dimensions of the openings and situated between the edges of the corresponding opening in the inserted position of said end portion in the volume.

In another aspect, an assembly process is described for an interior vehicle door trim using at least one such temporary fixing unit, and a vehicle door panel produced according to this assembly process; and also a vehicle door panel, having a housing provided with an interior opening and a trim designed to close the interior opening of said housing and delimit therewith a volume for housing components and/or functional modules, produced in accordance with this assembly process.

The invention will be better understood, using the description below, which relates to a preferred embodiment given as a non-limiting example, and explained with reference to the accompanying diagrammatic drawings.

### BRIEF DESCRIPTION OF THE DRAWINGS

FIG. 1 is a cross-sectional view of a male part and a corresponding opening of a temporary fixing unit embodying the principles to the present invention;

FIG. 2 is a view in side elevation illustrating a trim fitted temporarily in an opening of a vehicle door panel housing;

FIG. 3 is a reversed view of FIG. 2 illustrating the trim;

FIG. 4 is a view in perspective of a portion of the internal face of the trim on which is fitted a male part of a temporary fixing unit according to the invention; and

FIG. 5 is a view in perspective of a slider of a guided movement unit on which is arranged an opening corresponding to the male part illustrated in FIG. 4.

### DETAILED DESCRIPTION

As illustrated in the accompanying figures, a temporary fixing unit 1 for two components 2 and 3 that are preferably in the form of plates, panels or the like. At least two openings 4 are present in the region of the first component 2, and each of which opens into a hollow or open volume 4″. On the second component 3, at least two corresponding male parts 5 are provided and designed to be engaged elastically in said openings 4 and to be withdrawn therefrom without the need for a tool. This temporary fixing unit 1 is characterized in that each male part 5 has, as seen in the axial or engagement direction of this part, three portions 6, 7 and 8, namely, a first end portion 6, an intermediate portion 7 and a second end portion 8. The first end portion is at least slightly deformable and has lateral or sectional dimensions that are greater than the passage dimensions of the openings 4 in the absence of loading or constraint, and designed to traverse the corresponding opening 4 and to engage against the edges 4′ thereof in the inserted position of said first end portion 6 in the volume 4″. The second end portion 8 has lateral or sectional dimensions greater than the passage dimensions of the openings 4. The intermediate portion 7 of lateral or sectional dimensions is at least slightly smaller than the passage dimensions of the openings 4 and is situated between the edges 4′ of the corresponding opening 4 in the inserted position of said end portion 6 in the volume 4″.

The openings 4 may equally well be produced in the first component 2 in a part integral with this component 2 or in the region of a fixing site.

The lateral or sectional dimensions of the openings 4 correspond to the sectional dimensions in a plane perpendicular to the assembly direction of the second component 3 on the first component 2, in other words to the insertion direction of the first end portions 6 of the male parts 5 in the corresponding openings 4. The same applies for the lateral or sectional dimensions of the first and second end portions 6, 8 and of the intermediate portion 8 of the male part 5.

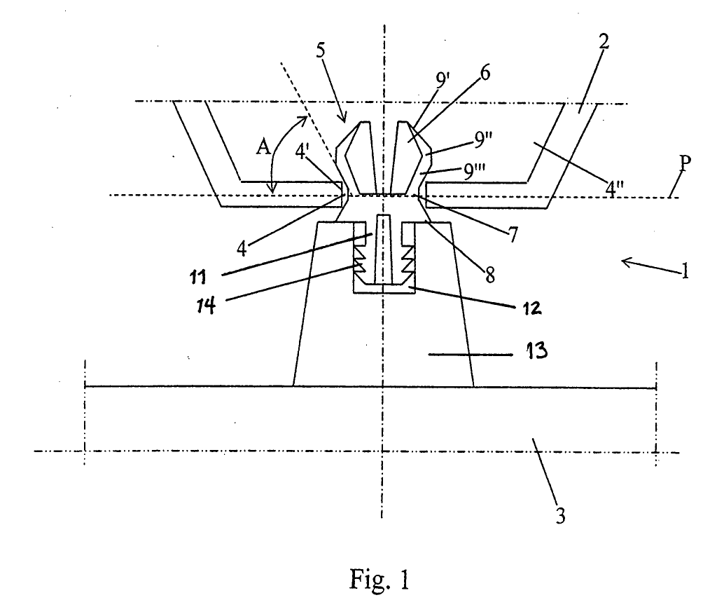

According to the invention, and as illustrated in more detail in FIG. 1, the first end portion 6 of each male part 5 may include of at least two elastic lugs 9, each comprising of three consecutive lug portions 9′, 9″ and 9′″.

First lug portions 9′ may have, in the region of their free end, a spacing smaller than the diameter of the opening 4 and be separated from each other as far as second intermediary lug portions 9″ with a spacing greater than the diameter of the opening 4 forming a guiding surface for introducing the first end portion 6 into the corresponding opening 4 and allowing progressive pinching of the lugs 9 during the introduction of the first end portion 6 in the corresponding opening 4. Third lug portions 9′″ may have, in the region of their ends adjacent to the intermediate lug portions 9″, a spacing greater than the diameter of the opening 4. The third lug portions 9′″ come closer to each other, as far as the first intermediate portion 7, and of smaller diameter than the opening 4. The surface of the third lug portions 9′″ form a stop for the edges 4′ of the opening when the end portion 6 is in the inserted position in the volume 4″. Moreover, the third lug portions 9′″ may form, with the axial plane P of said intermediate portion 7, an angle A determining the traction force needed to withdraw said end portion 6 from the volume 4″.

Thus, a temporary fixing unit 1 is produced in which the release or separation force of the first and second components 2 and 3 is predetermined depending on the angle A. In fact, the greater this angle, the greater the traction force that must be applied to withdraw the first end portion 6 of the male part 5. It is therefore possible, using the invention, to predetermine the force needed to separate the two components 2 and 3. In addition, and advantageously, this force can be readily reproduced.

As one skilled in the art will readily appreciate, a suitable value for the angle A will be chosen to guarantee both retention of the first end portion 6 of the male part in the corresponding opening 4 and a relatively easy withdrawal that does not require the use of special tools. Moreover, the value for the angle A will be chosen, preferably, so as to allow withdrawal of the first end portion 6 from the opening 4, without damaging the male part, such as for example severing the lug portions 9′, by relying only on the spacing and elasticity of said lug portions 9′.

Optionally, the edges of the openings 4 may be beveled to facilitate withdrawal and insertion of the first end portion 6 through the corresponding opening 4, or not beveled to increase the effort required on withdrawal and insertion.

Advantageously, the diameter of the second end portion 8 may increase linearly from the intermediate portion 7 to attain, in the region of its free end, a diameter greater than the diameter of the opening 4. In such a way, its lateral surface forms a stop for the edges 4′ of the opening 4 when the first end portion 6 is inserted in the corresponding opening 4. In this way, it is guaranteed that only the first end portion 6 may be introduced into the corresponding opening 4 and that the first and second components 2 and 3 will be held at a certain distance from each other, this distance corresponding substantially to the gap between the intermediate portion 8 and the body of the first component 3, in the insertion direction of the male part 5 into the corresponding opening 4.

According to a first variation of the invention, the second end portion 8 may be mounted on the second element 3. The male part 5 may therefore have, in the region of the central portion of its free end, a projecting portion 11 designed to be fitted in a corresponding cavity 12 arranged in the second component 3 or in a support 13 mounted or formed in a single piece on the second component 3.

Advantageously, said projecting portion 11 may have, on its side wall, anchoring teeth 14 to fix it in the cavity 12. These anchoring teeth 14 are retracted when they are inserted in the cavity 12 and are deployed by a traction force applied to the male part so as to be anchored in the walls of said cavity 12.

According to a second variant, the second component 3 and the second end portion 8 are produced in a single piece, so that said second component 3 forms said second end portion 8.

The temporary fixing unit 1 according to the present invention therefore has the advantage of connecting and separating two components 2 and 3 without the use of tools and of being reusable as it is not damaged either when temporarily fixing the components 2 and 3 together, or when separating them.

Moreover, after the release of the two components 2 and 3 connected temporarily by the temporary fixing unit 1 and when the trim 15 is finally mounted on the door panel in the opening 16, the components 2 and 3 increase the resistance of the door panel unit, particularly against lateral impact.

The present invention also relates to a process for fitting an interior vehicle door trim, said trim being designed to close the interior opening of the housing of a door panel and to delimit with said housing a volume for housing functional components and/or modules, such a process may comprise the steps of:

i) providing a vehicle door panel 17 having a housing 17′ with an opening 16 for fitting functional components, a functional component, in particular a guided movement device 18 for the moving window 18′ of the door, and a trim 15 designed to be fitted on the opening 16 to close it,

ii) fitting the trim 15 on the guided movement device 18 for the window 18′,

iii) fitting the guided movement device 18 in its service position in the housing 17′ through the opening 16, while holding the trim 15 in an offset position to allow access to the housing volume,

iv) fixing and possibly adjusting the guided movement device 18 on the door panel, in the opening 16,

v) assembling, fixing and possibly adjusting the other functional components in the housing 17′ through the opening 16,

vi) separating the trim 15 from the guided movement device 18 for the window 18′, and

vii) plugging the opening 16 and closing the housing volume by the final assembly and fixing of the trim 15 on the door panel in the opening 16.

The process is characterized in that assembly of the trim 15 on the guided movement device 18 for the window 18′ is produced by means of a temporary fixing unit 1 embodied by the invention.

The temporary fixing unit 1 thus allows the trim 15 to be held in a certain position (preferably off set) on the door panel 17 by means of the guided movement device 18 for the window 18′. To do this, the male 5 and female 4 parts of the temporary fixing unit 1 are situated respectively in the region of the guided movement device 18 for the window 18′ and in the region of the internal face of the trim 15, or the other way round.

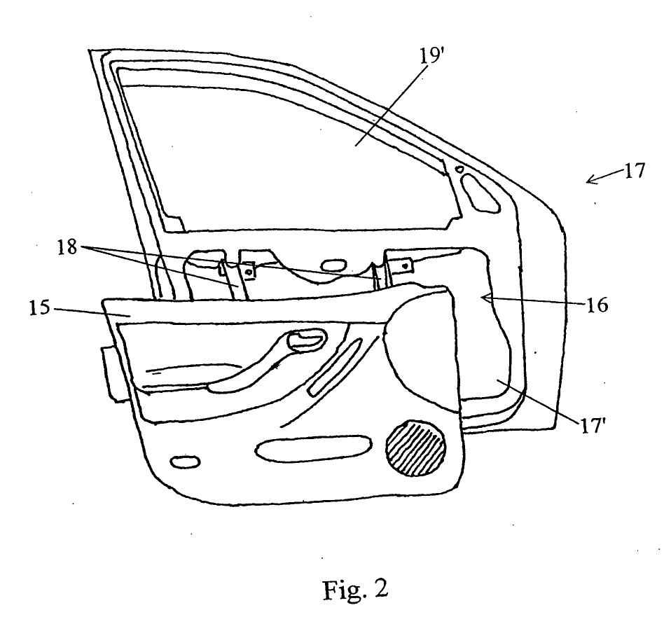

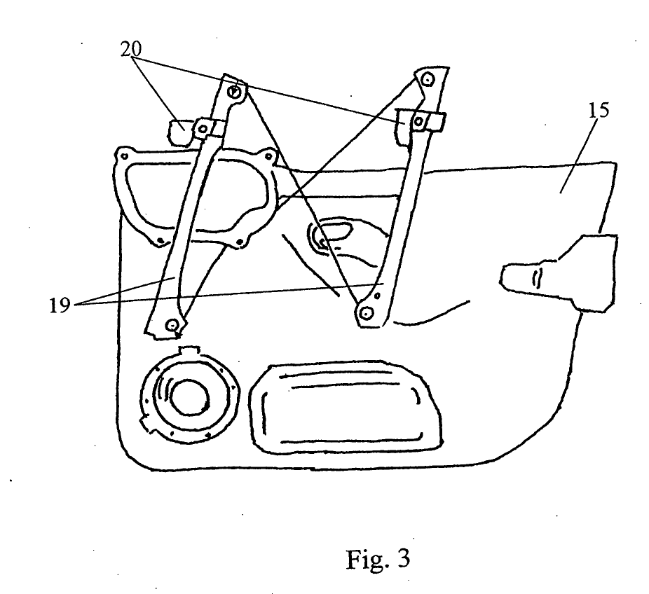

When the guided movement device is fixed in its service position on the door panel, in the opening 16, the offset position of the trim 15 allows access to the housing volume for assembling all the other functional components, such as a loudspeaker. This offset position, produced using the temporary fixing unit 1 of the present invention and illustrated in FIG. 2, thus allows recourse to a supplementary retention or support means of the trim 15 during assembly of all the functional elements to be avoided.

In the process according to the invention, stage v) may comprise the assembly of the window 18′ on two sliders 19 and the corresponding guide rods 20 of the guided movement device 18.

Preferably, each slider 19 has two openings 4 co-operating with complementary male parts 5 of the trim 15, and the openings 4 and male parts 5 are arranged respectively on the sliders 19 and on the internal face of the trim 15 in such a way that in the assembly position of the guided movement device 18 in its service position in the housing 17′ through the opening 16, the trim 15 is held in a position offset laterally and downwards in relation to the opening 16. Thus, assembly of the functional components in the housing 17′ is made easier.

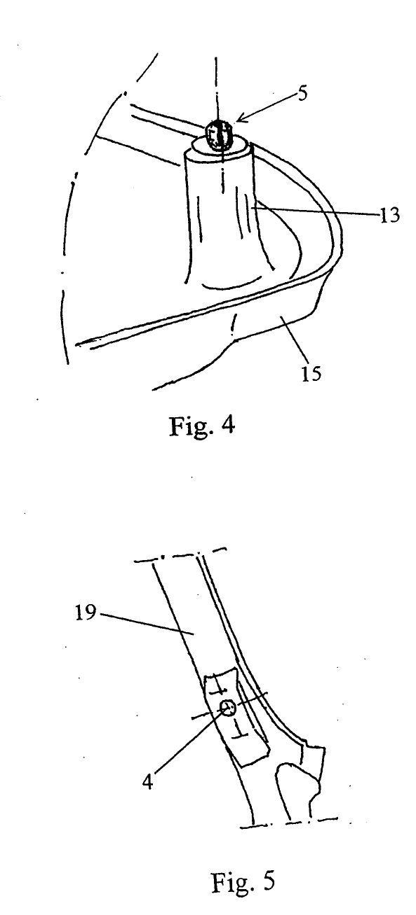

FIG. 4 illustrates, as an embodiment, a portion of the internal face of a trim 15 having a support 13 molded on said internal face of the trim 15 in which is fitted the second end portion 8 of a male part. FIG. 5 illustrates a corresponding opening 4 produced in a part integral with the guided movement device 18.

Although the invention provides for the use of two temporary fixing units 1 for temporarily fixing the trim 15 on the guided movement device 18, it is possible, depending on the weight of the trim 15, to use more than two temporary fixing units 1 or less. Their location may be chosen to guarantee both stability for assembly of the guided movement device 18 in its service position in the housing 17′ and stability for assembly of the trim 15 on said guided movement device 18.

As described above, the traction force needed to release the trim 15 is determined by the angle A formed between the lug portions 9′″ of the male parts 5 of the temporary fixing unit 1 and the axial plane P of the intermediate portion 7 of said male parts 5. Thus, the release force can be reproduced and does not require the use of a tool.

The operation of assembling the trim 15 on the door panel 15 in the opening 16, in order to finally fix said trim 15, may be guided by guiding and centering means, which may be arranged on the faces of the trim 15 and of the opening 16 designed to be brought into contact with each other. Advantageously, the final fixing means of the trim 15 on the door panel in the opening 16 may form these guiding and centering means and may be in the form, for example, of screws co-operating with corresponding nuts.

It is also possible to envisage producing these guiding means in the form of hooks or fixing means by elastic deformation or by engagement.

Where the trim 15 is fixed by bonding on the door panel, special guiding and centering means may be provided.

The present invention also relates to a vehicle door panel, consisting of a housing provided with an interior opening and a trim designed to close the interior opening of said housing and delimit therewith a volume for housing functional components and/or modules, characterized in that it is produced following the assembly process according to the present invention.

Of course, the invention is not limited to the embodiment described and illustrated in the accompanying drawings. Modifications are possible, particularly from the point of view of the structure of the various components or by substitution of technical equivalents, without thereby departing from the scope of protection of the invention.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I claim:

1. An arrangement of a temporary fixing unit for two components generally in the form of plates or panels, the unit comprising at least two openings in one of the components, each opening into an open volume, at least two corresponding male parts on the other component, the male parts including portions adapted to be elastically engaged in the openings and to be released therefrom without the need for a tool,
seen from the axial or engagement direction of this the male part, each male part having a first end portion that is at least slightly deformable and of lateral dimensions greater than the passage dimensions of the openings in the absence of loading or constraint, each male part being designed to traverse the corresponding opening and engage against the edges thereof in the inserted position of said first end portion in the open volume, a second end portion of lateral dimensions greater than the passage dimensions of the openings, and an intermediate portion of lateral dimensions at least slightly less than the passage dimensions of the openings and situated between the edges of the corresponding opening in the inserted position of said end portion in the open volume.

2. The unit according to claim 1, wherein the first end portion of each male part includes of at least two elastic lugs each having three consecutive lug portions being first lug portions, second lug portions and third lug portions, the first lug portions having in the region of their free end a spacing smaller than the diameter of the opening and diverging in the region of their other ends adjacent other second intermediary lug portions from each other to a spacing greater than the diameter of the opening, the first lug portions forming a guiding surface for introducing the first end portion into the corresponding opening allowing progressive pinching of said lugs during introduction of the first end portion in the corresponding opening, the third lug portions having in the region of their ends adjacent to the intermediate lug portions a spacing greater than the diameter of the opening and converging closer to each other in the region of their other ends adjacent the intermediate portion to a size smaller diameter than the opening, the surface of said third lug portions forming a stop for the edges of the opening when the end portion is in the inserted position in the volume, said third lug portions forming with the axial plane of said intermediate portion an angle (A) determining the traction force needed to withdraw said end portion from the open volume.

3. The unit according to claim 2, wherein the diameter of the second end portion increases from the intermediate portion to attain in the region of its free end a diameter greater than the diameter of the opening in such a way that its lateral surface forms a stop for the edges of the opening when the first end portion is inserted in the corresponding opening.

4. The unit, according claim 1, wherein the second end portion is mounted on the second component.

5. The unit according to claim 4, wherein each of the male parts has, in the region of the central portion of its free end, a projecting portion fitted in a corresponding cavity of the second component.

6. The unit according to claim 5, wherein the projecting portion has on a side wall thereof anchoring teeth engaging it with the cavity.

7. The unit according to claim 1 wherein the second component forms the second end portion.

8. A method for assembly an interior vehicle door trim, said trim being designed to close the interior opening of the housing of a door panel and to delimit with said housing a volume for housing functional components, the process comprising:
providing a vehicle door panel having a housing with an opening for fitting functional components, a functional component including a guided movement device for a window, of the door, and a trim configured to be fitted on the opening to close;
fitting the trim on the guided movement device for the window, fitting the guided movement device in a service position in the housing through the opening and holding the trim in an offset position to allow access to the housing volume;
fixing the guided movement device on the door panel in the opening, separating the trim from the guided movement device for the window; and
closing the housing volume by the final assembly and fixing of the trim on the door panel in the opening;
wherein the trim is fitted on the guided movement device of the window by means of a temporary fixing unit.

9. The method according to claim 8, further comprises fitting of a window on a slider and a guide rod of the guided movement device.

10. The method according to claim 9, wherein the slider has two openings co-operating with complementary male parts of the trim.

11. The method according to claim 10, wherein the openings and the male parts are arranged respectively on the slider and on the internal face of the trim in such a way that in the assembly position of the guided movement device in its service position in the housing through the opening, the trim is held in a position offset laterally and downwards in relation to the opening.

12. The method according to claim 8, wherein the final and fixing assembly of the trim on the door panel is guided by guiding and centering means.

13. The method according to claim 12, wherein the guiding and centering means is formed on the door panel.

14. A vehicle door panel produced by the method of claim 8.
